(19) United States
(12) Patent Application Publication
(10) Pub. No.: US 2011/0081622 A1
(43) Pub. Date: Apr. 7, 2011

(54) SELF-LIGATING BRACKET WITH UNIVERSAL APPLICATION

(76) Inventor: Cameron Mashouf, San Jose, CA (US)

(21) Appl. No.: 12/573,199

(22) Filed: Oct. 5, 2009

(51) Int. Cl. A61C 7/24

(52) U.S. Cl. 433/10

(57) ABSTRACT

A compact orthodontic bracket that employs a simple method of self-ligation, is compatible with both permanent and deciduous teeth and is less expensive to manufacture than existing commercial brackets. The bracket utilizes a rotary plate that covers an arch wire slot when closed and can be pivotably opened to allow arch wire changes. Ligation may also be augmented using conventional ligatures on the paired tie wings. The simplicity of the ligating mechanism allows manufacturing of a smaller bracket. It is also less vulnerable to the clogging effects of salivary deposits than commercial self-ligating brackets currently in use.

### FIELD OF INVENTION

This invention broadly relates generally to the field of orthodontic brackets. More specifically, the present invention discloses a self-ligating orthodontic bracket suitable for use on both permanent and deciduous teeth.

### BRIEF DESCRIPTION OF THE DRAWINGS

FIG. 1 is a perspective view of the bracket assembly in closed position

FIG. 2 is a perspective view of the bracket assembly in open position

FIG. 3 is an anterior view of the bracket assembly showing the plane of movement of the rotary plate

FIG. 3A is a side view of the rotary plate showing functional areas

FIG. 4 is a superior view of the bracket assembly in intermediate position

FIG. 5 is a perspective view of the bracket assembly in intermediate position

FIG. 6 is a superior view of the bracket assembly in closed position

FIG. 7 is a sectional view showing the relation of the rotary plate to the bracket assembly body

FIG. 8 is a exploded view showing the relationship between the rotary plate, rotary plate pin, and the bracket assembly body

FIGS. 8A and 8B are perspective views of the rotary arm showing the relationship of the tool to the rotary plate access slot FIG. 9 is a perspective view of the bracket assembly employing conventional ligatures

FIG. 10 shows upper and lower dental quadrants employing a 2×4 appliance

FIG. 11 shows upper and lower dental quadrants employing an 8×4 appliance

### BACKGROUND OF THE INVENTION

The modern orthodontic bracket was developed by Dr. Edward H. Angle and became commercially available in the early 1900's. In spite of significant improvements in design, materials and manufacturing processes that have occurred since Dr. Angle's time, the biomechanical functioning of orthodontic brackets remain essentially unchanged.

A variety of orthodontic brackets have been designed over the years generally incorporating varied bonding bases connected to an orthodontic bracket body. The bonding base is connected to the bracket body by brazing or other means. A bracket can be also fabricated as a one piece unit using a casting method. The bonding pad provides the interface for a mechanical bond between the bracket and the tooth.

Once the brackets are bonded to the teeth, orthodontic wires are installed in the bracket's arch slot. Orthodontic wire(s) are the guiding mechanism which combined with elastic or spring traction move the teeth to a predetermined position based on a treatment plan created by an orthodontist. In order to engage the archwire in the arch slots of a series of brackets, it is common to use elastomeric, steel ligature or other means of ligation to retain a sequential series of archwires typically needed during the course of orthodontic treatment. Conventional ligatures are looped or lassoed over the tie-wing structures of each bracket thus positively retaining the archwire in its corresponding slot in the bracket(s). During orthodontic treatment, an archwire normally extends around the ark of the teeth and is ligated into the archwire slots of all of the brackets of a patient's upper or lower dental arch. A patient will normally be treated with one set of brackets and a set of archwires for the upper dental arch and another set for the lower.

Central to tooth movement function of the orthodontic bracket is the archwire slot. The archwire slot is a horizontally oriented, outwardly opening trough spanning a bracket's labial or buccal surface. The orthodontic bracket designed by Dr. Angle is known as the edgewise bracket, Edgewise is a descriptive term referring to the rectangular interfit of the bracket's slot and the arch wire typically employed for edgewise orthodontic therapy. The edgewise bracket is designed to accommodate an archwire which is rectangular in cross-section and is retained in the rectangular-shaped slot by ligation means that positively hold an archwire fully constrained and seated within the bracket's slot.

Not all archwires used in edgewise therapy are rectangular in cross-section. Edgewise orthodontic treatment calls for the use of a progressive series of archwires. Typically, smaller, round wires are used at the beginning of treatment. Such wires exhibit a low spring rate and low modulus, and are capable of handling the large bracket-to-bracket deflection encountered at the beginning of treatment without showing permanent deformation. The phase of treatment where the attending orthodontist may use a series of relatively small, but progressively larger and stiffer round wires is known as the “leveling and alignment” phase.

Round archwires used early in treatment are not considered as being true edgewise wires because being round in cross-section; they are incapable of imparting tortional forces against the flat slot walls and floor. In orthodontics, this kind of force acting on the roots of the teeth is called “torque”. A tooth can also be uprighted laterally, known as correction in terms of “angulation”. An archwire can impart corrective forces known as “rotation” which cause a tooth to desirably rotate around its central axis. Other corrective forces can be transmitted from an arch wire to a tooth through its corresponding bracket that tends to intrude or extrude into or out of its bony support. Such corrective forces are known as “intrusive” or “extrusive”. An archwire can influence a tooth to move bodily outward or inward and such forces are said to position a tooth in terms of “expansion” or “constriction”. Since the Edgewise relationship between an archwire and a bracket's slot does not preclude a relative sliding movement between an archwire and a bracket, other tractive or compressive forces may be applied to a tooth that urge a tooth to desirably slide along the mesio-distal extent of an archwire into a new position. Over the course of orthodontic treatment, patient's teeth are moved to corrected positions through a combination of most, if not all of these forces acting on the teeth.

As can be appreciated, the use of larger, harder, square and rectangular archwires can only be initiated after significant tooth movement during the so called “leveling and alignment stage” has been achieved.

Edgewise brackets in current use incorporate tie wings which are extensions that project upwardly and downwardly in a gingival-occlusal orientation and require the use of ligatures or ligating modules to hold the archwire within the archwire slot. The ligatures or ligating modules are typically donut-shaped elastomeric rings or wires that are stretched around or twisted around the tie wings.

The use of such ligatures or ligating modules presents a number of inherent disadvantages. The small size of the ligatures or ligating modules requires substantial time for installation of the archwire. Because the orthodontist will typically make numerous adjustments to the archwires throughout orthodontic treatment, the orthodontist or the orthodontist's staff will have to remove and replace the ligatures or ligating modules numerous times.

Hygiene is another problem since the use of ligatures or ligating modules increases the areas that food particles are likely to be trapped. The elastic modules (O-rings) are extremely plaque retentive and greatly increase the number of microorganisms attached to brackets during treatment. This increases the incidence of enamel discoloration and decalcification during treatment. Furthermore, with movement due to chewing or other activities, the ligatures or ligating modules may become stretched or detached altogether, allowing the archwire to disengage from the archwire slot.

Friction presents a separate problem since traditional bracket systems rely on the ligatures or ligating modules to hold the archwire within the slot of the bracket. The two areas that hold the archwire most securely are the mesial and distal ends of the bracket where the elastomeric or wire ligatures make contact with the archwire binding the arch wire. This binding or “bungee-cord effect” creates friction during orthodontic tooth movement and consequently increases the force needed for sliding movement particularly during the early “leveling and alignment” phase of treatment. The additional force required to move the teeth creates additional discomfort for patients and increases the time for completion of treatment.

By contrast, self-ligating bracket systems, or brackets that do not require traditional ligatures or ligating modules, have been developed which rely on a principle that forces employed to reposition teeth should not overwhelm the supporting periodontium and facial musculature. Forces applied should instead be minimized to a level just large enough to stimulate cellular activity and, thus, tooth movement without unnecessarily disturbing the vascular supply to the periodontium.

Several self-locking or self-ligating orthodontic brackets have been designed. However, most of these brackets have complex designs, incorporating features requiring prohibitively expensive machining operations or comprising multiple separate parts, which in turn increases the bulkiness of the brackets, clogging of the moving parts and ultimately the chances of failure.

An early alternative to the time-consuming ligation step was described in U.S. Pat. No. 4,248,588 (Hanson). Hanson disclosed an all-metallic, self-ligating bracket. Hanson's bracket assembly utilizes a retaining clip capable of being slidingly positioned in a fully open or fully closed position. In the open position, an archwire can be inserted into Hanson's bracket and, in the closed position, the archwire will be retained. The archwire-contacting points of the spring temper sliding clip actively hold an archwire in position in a slot, but it is also capable of limited flexing and limited torsion. Such flexing and torsioning capabilities act in a manner similar to the spring property of traditional elastomeric ligatures.

More recent variations of self-ligating brackets utilizing clips on the bracket body to hold an archwire in place are found in U.S. Pat. Nos. 6,554,612 and 6,582,226.

Another innovation in the field of self-ligating brackets appeared in U.S. Pat. No. 5,474,445 (Voudouris). Voudouris introduced an all-metallic self-ligating bracket assembly configured to achieve a fully open and fully closed archwire retaining action through the use of a pivoting clip rather than a sliding clip as used by Hanson. Unlike the Hanson bracket, Voudouris provided the feature of self-ligation in combination with Siamese-type tie wings found in traditional brackets. The features of Voudouris' bracket provide the desirable selective ligation option of conventional brackets where either a distal or a mesial portion of the bracket can be ligated if needed to achieve a rotational couple, thereby eliminating the need for the spring clip to actively function as taught by Hanson.

Two sliding self-ligating brackets were introduced by Damon, the SL I and SL II brackets (see U.S. Pat. No. 6,071,118). Both are edgewise twin brackets. The difference between the two is that the first features a labial cover that straddles the tie wings, while the second incorporates a flat, rectangular slide between the tie wings. In both versions, the slide moves incisally on the maxillary brackets and gingivally on the mandibular brackets. Special opening and closing pliers are required to move the slide.

U.S. Pat. No. 6,726,474 issued to Spencer describes a self-ligating module for removable attachment to a conventional orthodontic bracket. A clip portion of the module pivots between an open position in which the archwire slot of the bracket is open to receive an archwire, and a closed position in which the archwire is secured in the archwire. The module can be readily removed when the self-ligating feature is not needed.

Patent publication, US 2007/0259304 A1, discloses a self-ligating bracket with a rotary ligating cover. This bracket provides an archwire slot formed upon the base and a rotary ligating cover selectively rotatable between an open position permitting access to the archwire slot and a closed position completely covering the archwire slot. One or more locking features hold the rotary cover in a closed position.

There are many other variations and adaptations of the foregoing self-ligating brackets that have been developed by others. See, e.g., U.S. Pat. No. 4,786,252 to Fujita, U.S. Pat. No. 4,712,999 to Rosenberg, U.S. Pat. No. 4,492,573 to Hanson, U.S. Pat. No. 4,103,423 to Kessel, and U.S. Pat. No. 6,071,119 to Christoff et al.

In reviewing the general field of self-ligating brackets, both proposed and commercialized, all versions employ a vertically sliding clip, a vertically rotating plastic cover held by a hinge, or a circular rotary cover; all of which require increased size of the bracket in depth, width or height to accommodate the complex ligating mechanism. Further, they include multiple parts which make them prone to failure and require complex and costly manufacturing processes.

In the case of self-ligating brackets that employ a sliding mechanism, a common problem is the accumulation of tarter in the guiding grooves that hold the clip and allow the clip to slide between the open and closed position. In such circumstances, the self-ligating clip gets stuck in the closed position requiring use of tarter solvents and/or excessive manual pressure to open a stuck ligation slide. Clogging-up of the slide mechanism can be a source of considerable anxiety, pain and discomfort for the patient.

Another disadvantage of the existing sliding and rotary self-ligating brackets is that the entire front surface of the bracket is covered by the self-ligation mechanism blocking the arch-wire slot and the tie wings and making them inaccessible to conventional elastic or steel tie. The archwire which is not secured in the depth of the slot does not fully express the built-in tip and torque of the bracket. The inherent inability of the existing self-ligating brackets to take full advantage of the built-in tip and torque becomes a problem in the finishing stages of orthodontic treatment.

In spite of many advantages brought about by the self-ligating brackets, they pose several new problems and disadvantages, which are successfully addressed by the present invention.

One important advantage of the claimed bracket assembly is simplified management of the conflicting mechanical requirements of the early versus late stages of treatment. The self-ligating functionality can be used during early stages of treatment where less archwire friction is desirable. Moreover, the bracket assembly is able to accommodate traditional ligatures providing more positive torque control when needed during later stages of treatment.

Another significant advantage of the present invention is its compact design. Presently available self-ligating brackets inherently consist of multiple parts whereas conventional brackets are manufactured as monolithic structures. Because self-ligating brackets have complex structures associated with multiple parts, and because self-ligating brackets embody additional features to support the capability of self-ligatibility, they are inherently more bulky and generally extent further in one or more of their dimensions. From the patient's point of view, larger or more prominent brackets are undesirable both for aesthetic reasons of being more visible and due to greater irritation they can cause to the insides of the cheeks and lips. The present invention allows for reduction in the size of the bracket to any degree without compromising the self-ligating mechanical integrity of the bracket.

A further advantage of the simple, open design of the present invention is that it does not afford an opportunity for the accumulation of tartar that can interfere with the self-ligation mechanism. As noted previously, tartar accumulation, particularly in self-ligating brackets using a slide mechanism, can often have an adverse effect on the orthodontist's ability to manipulate the ligation mechanism as well as the patient's comfort.

### DETAILED DESCRIPTION OF THE INVENTION

Details of the illustrated orthodontic bracket are intended to be interpreted as being merely illustrative and are not to be taken as being restrictive of the practical combinations of such features within the scope of this disclosure and the claims which follow.

### Orientation

The following terms are used in this description to facilitate interpretation of the illustrations.

An anterior surface is directed buccally in relation to the supported tooth. A posterior surface is directed lingually in relation to the supported tooth.

Superior is toward the occlusal plane. Inferior is toward the gingival plane. Transverse is parallel to the occlusal plane. Upright is parallel to the gingival-occlusal plane. Height is the bracket dimension between the gingival and occlusal planes.

A leading edge is the mesially directed side surface of the bracket assembly. A trailing edge is the distally directed side surface of the bracket assembly.

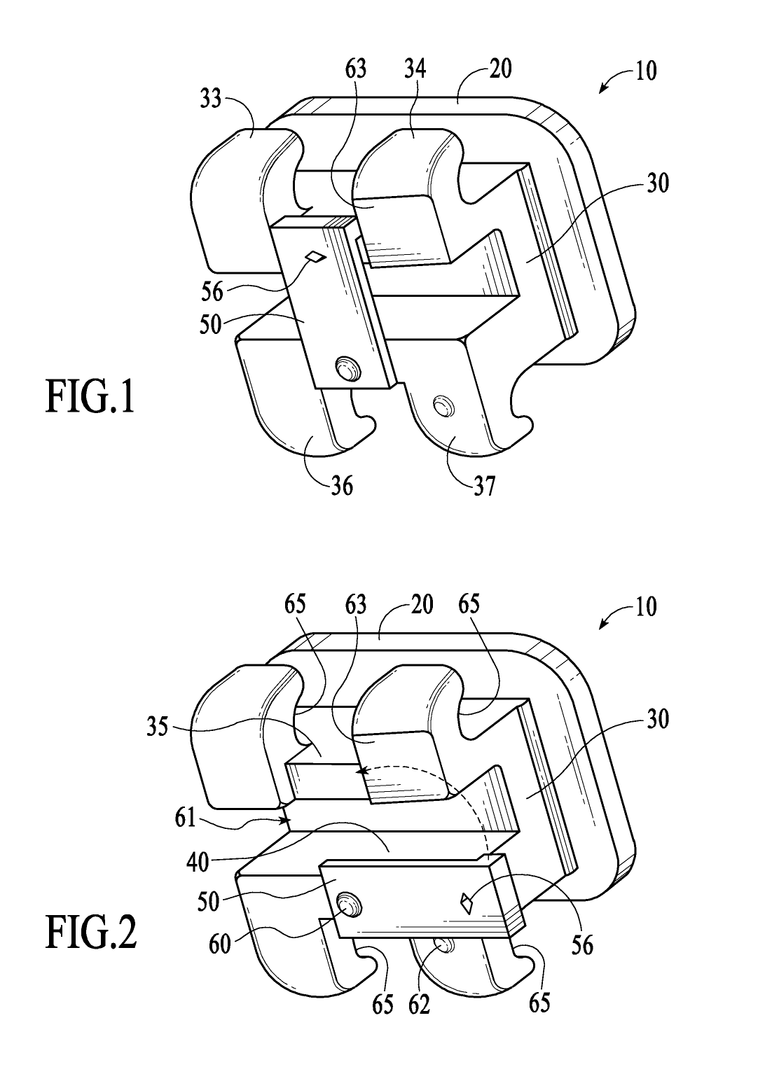

FIGS. 1 and 2 are perspective views of one possible embodiment of the self-ligating bracket assembly 10, many other embodiments are possible.

The bracket assembly 10 is comprised of bonding pad 20 for attachment to a tooth, and bracket body 30 for engagement of an archwire.

The superior portion of bracket body 30 includes an upper distal tie wing 33 and upper mesial tie wing 34 separated by upper intermediate body section 35. The inferior portion of bracket body 30 includes lower distal tie wing 36 and lower mesial tie wing 37 separated by a lower intermediate body section 40 of bracket body 30.

Rotary plate 50 is pivotably attached to lower intermediate body section 40 by rotary plate pin 60. FIG. 1 shows rotary plate 60 in closed position covering archwire slot 61. Rotary plate stop 62 located on the anterior surface of lower mesial tie wing 37 prevents rotary plate 50 from falling below the transverse plane when in the open position as in FIG. 2.

Posterior curved tie wing surfaces 65 allow for ligation by means of traditional metal or elastic ligatures in situations where rotary plate 50 is either still in place or has been removed from bracket body 30.

The anterior surface of upper mesial tie wing 34 is contoured to facilitate the movement of rotary plate 50 from the closed to the open position. Specifically, contour area 63 is sloped posteriorly toward the mesial in the transverse plane.

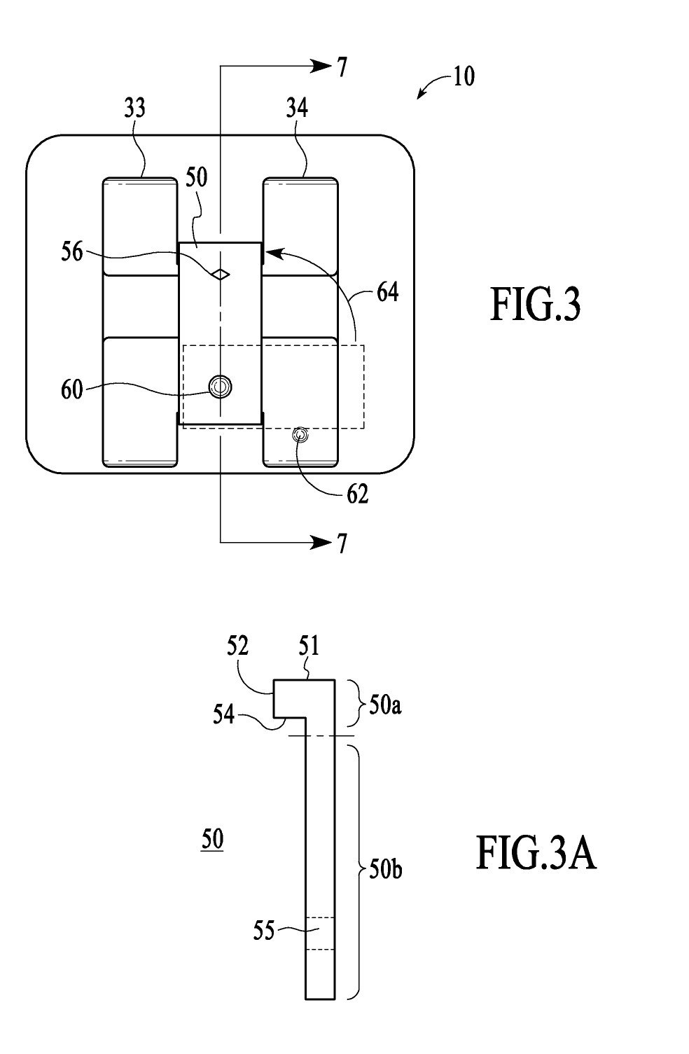

FIG. 3 is an anterior view of bracket assembly 10 with rotary plate 50 shown in the upright closed position. Phantom lines represent rotary plate 50 in the transverse open position. Arrow 25 shows the direction of movement of rotary plate 50 as it pivots on rotary plate pin 60 between open and closed positions.

Rotary plate access slot 56 in the superior surface of rotary plate 60 provides a point of entry for an instrument facilitating opening or closing of rotary plate 50.

FIG. 3A is a side view of rotary plate 50. L-shaped rotary plate 50 can be viewed as having two functional areas separated in FIG. 3a by a phantom line, a superior rotary plate tab 50a functionally related to the process of opening and closing the rotary plate and an inferior stem 50b functioning to retain an archwire 66 when rotary plate 50 is in the closed position. Surfaces involved in the functionality of rotary plate tab 50a are superior tab surface 51, posterior tab surface 52 and inferior tab surface 54. Also shown in FIG. 3A are rotary plate access slot 56 and rotary plate pin slot 55.

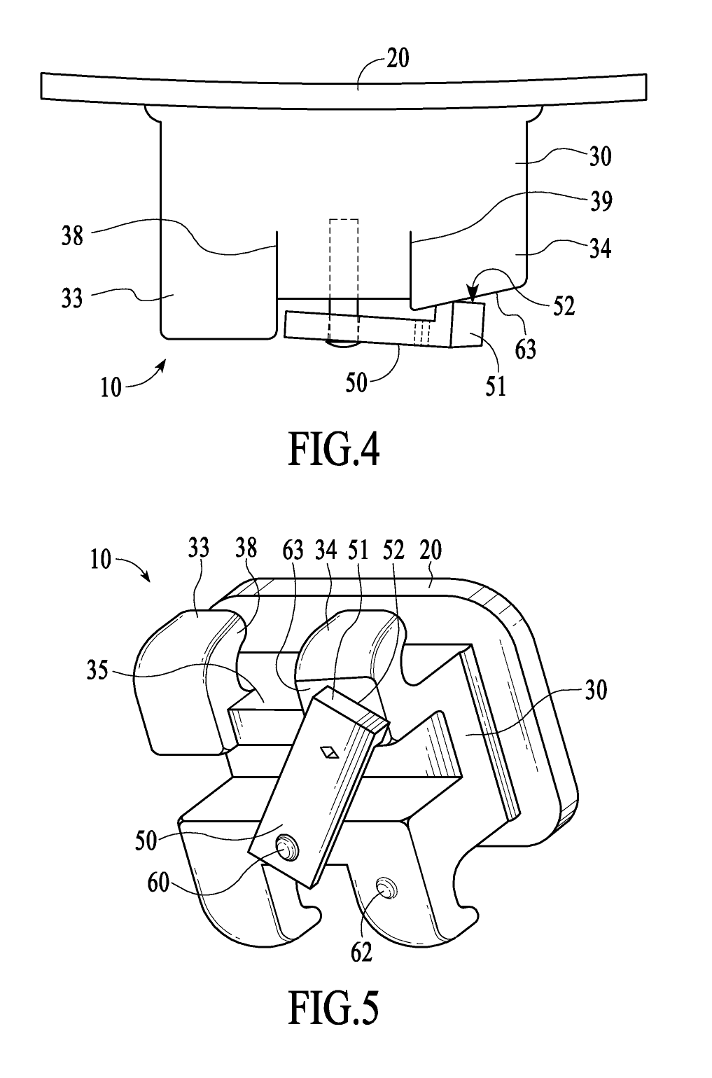

FIG. 4, a superior view of bracket assembly 10, is illustrative of the fastening mechanism for this particular embodiment. Other fastening methods may be utilized in other embodiments. Shown here is rotary plate 50 in an intermediate position between open and closed positions. For the purpose of viewer orientation it is apparent that the viewer is looking down and at an angle upon tab superior surface 51. Movement of rotary plate 50 from the open to closed position may be accomplished through the application of force by means of a tool 80 adapted for insertion into rotary plate access slot 56, or by manipulation of rotary plate tab 50a with the practitioner's fingers. Posterior tab surface 52 of rotary plate 60 is shown in contact with contour area 63. Due to the applied force, contour area 63 is effectively lifting rotary plate 50 anteriorly as it moves toward the ultimate closed position between the interior surface of upper distal tie wing 38 and the interior surface of upper mesial tie wing 39. Lifting of rotary plate 50 is facilitated by flexibility in rotary plate stem 50b allowing rotary plate 50 to bend slightly toward the anterior during the closing process.

FIG. 5 is a perspective view of bracket assembly 10 also showing rotary plate 50 in an intermediate position between open and closed.

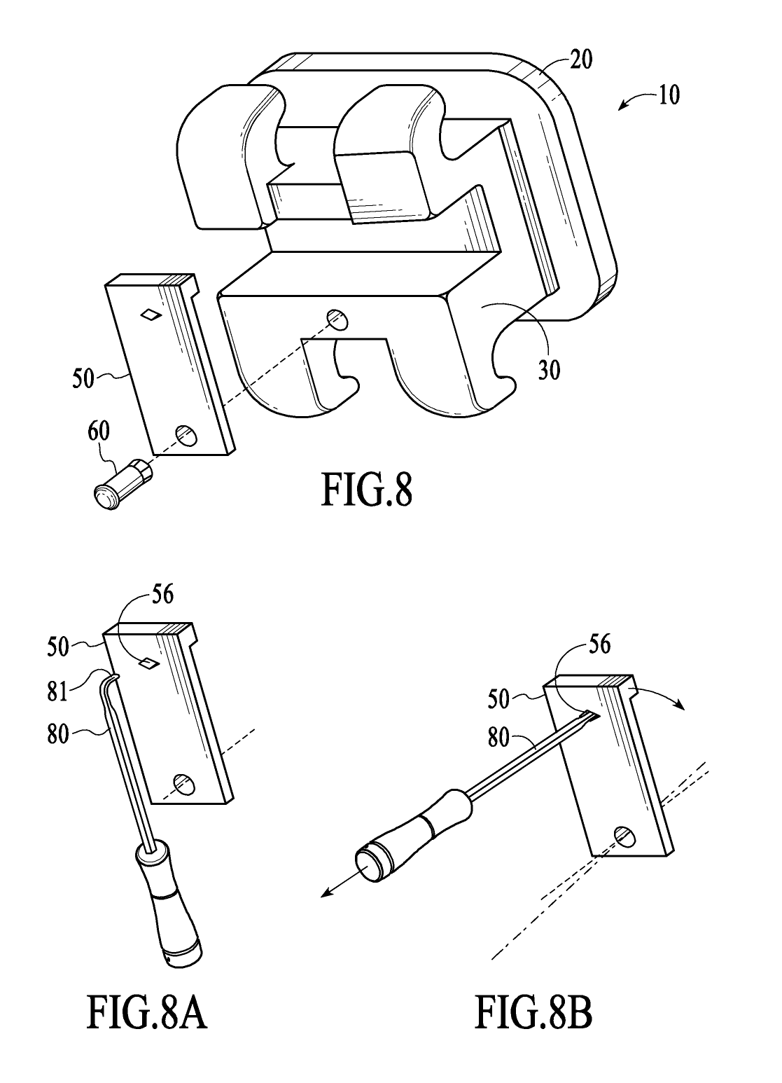

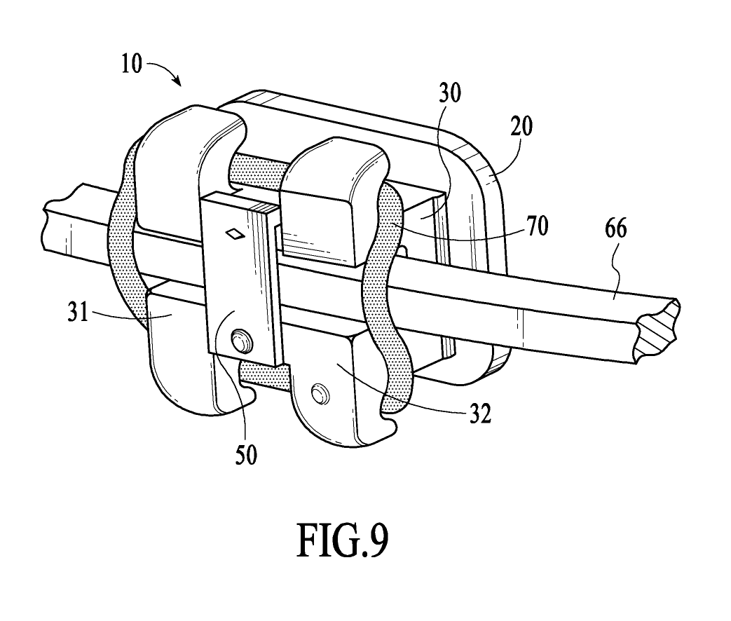

FIGS. 8A and 8B are perspective views of rotary plate 50 showing the relationship of tool appendage 81 to exterior to rotary plate access slot 56 as used for manipulation of rotary plate 50.

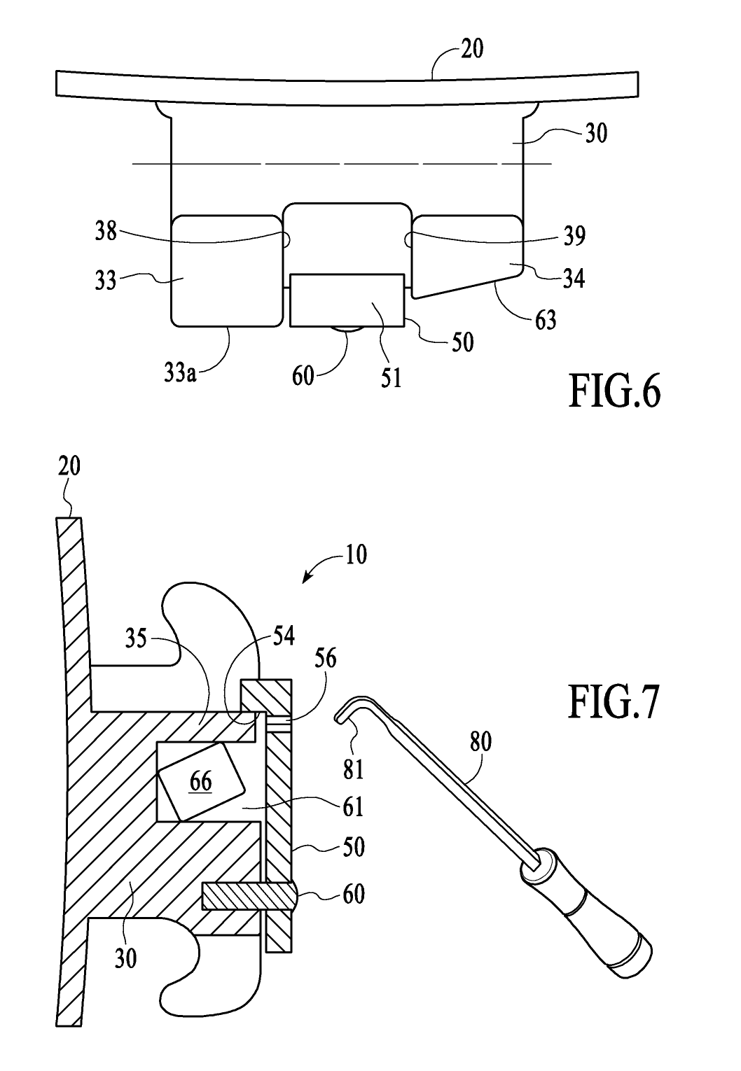

FIG. 6 is a superior view of bracket assembly 10 showing rotary plate 50 in closed position. This view highlights the importance of tie wing surface participation in both the fastening mechanism and retention of rotary plate 50 once in the closed position. It is apparent that movement of rotary plate 50 in the transverse plane is limited by the interior surface of upper distal tie wing 38 and interior surface of upper mesial tie wing 39. As described previously, the anterior surface of upper mesial tie wing 34 is specially sloped creating contour area 53 to interface with rotary plate tab 50a during the fastening process. Also, the anterior surface of upper distal tie wing 33a is extended slightly toward the anterior to prevent rotary plate 50 from moving beyond the interior surface of upper distal tie wing 38 when snapped into the closed position.

FIG. 7 is a sectional view of bracket assembly 10 showing rotary plate 50 in closed position, passively retaining archwire 66 within archwire slot 61. Rotary plate 50 is held securely in place superiorly by contact between upper intermediate body section 35 and inferior tab surface 54, and inferiorly by rotary plate pin 60 anchored in bracket body 30.

Also shown in FIG. 7 is tool 80 with tool appendage 81 designed to interface with rotary plate access slot 56. Use of tool 80 allows the practitioner to flex rotary plate stem 50b anteriorly in order to effect opening or closing of rotary plate 50.

FIG. 8 is an exploded perspective view of bracket assembly 10 showing rotary plate pin 60 passing through and anchoring rotary plate 50 by attachment to bracket body 30.

Being mounted on a conventional Siamese twin edgewise bracket assembly 10 (FIG. 9) with appropriate built-in torque, the small rotary plate 50 provides the convenience and the advantage of reduced friction, hence maximum efficiency in the early stages of treatment. Because the self-ligating rotary plate 50 covers only the center part of bracket body 30, it provides the practitioner with the option of using elastic or steel ligatures 70 on distal tie wing 31 or mesial tie wing 32 for rotational movements. Additionally, a single elastic or steel ligature 70 can be placed over the ligating plate around all four tie wings for more positive torque control as shown in FIG. 9. If necessary, in the end stages of treatment the ligating rotary plate 50 can be removed with commonly available orthodontic tools to allow the practitioner the use of tie wings alone. The bracket assembly 10 without rotary plate 50 can then function as a conventional Siamese twin edgewise holding archwire 66 with either elastomeric modules or steel ligature ties. The latter mode of ligation provides maximum degree of torque control.

Up to the present time, all self-ligating orthodontic brackets have been designed for permanent teeth. There are no brackets that fit the smaller size of the deciduous teeth. Due to the simplicity of the ligation mechanism of bracket assembly 10, the present invention allows for miniaturization of bracket assembly 10 to fit the smaller crown size of the deciduous teeth. Inclusion of the deciduous teeth in the treatment increases the efficiency of mixed-dentition treatment and allows the practitioner to take advantage of the added anchorage value that the deciduous teeth provide to correct many of the dental misalignments in their initial stage of development.

Currently, various designs of self-ligating brackets are available for permanent teeth. The self-ligating bracket assembly 10 may be used on deciduous teeth in combination with any of the presently available self-ligating systems on the permanent teeth.

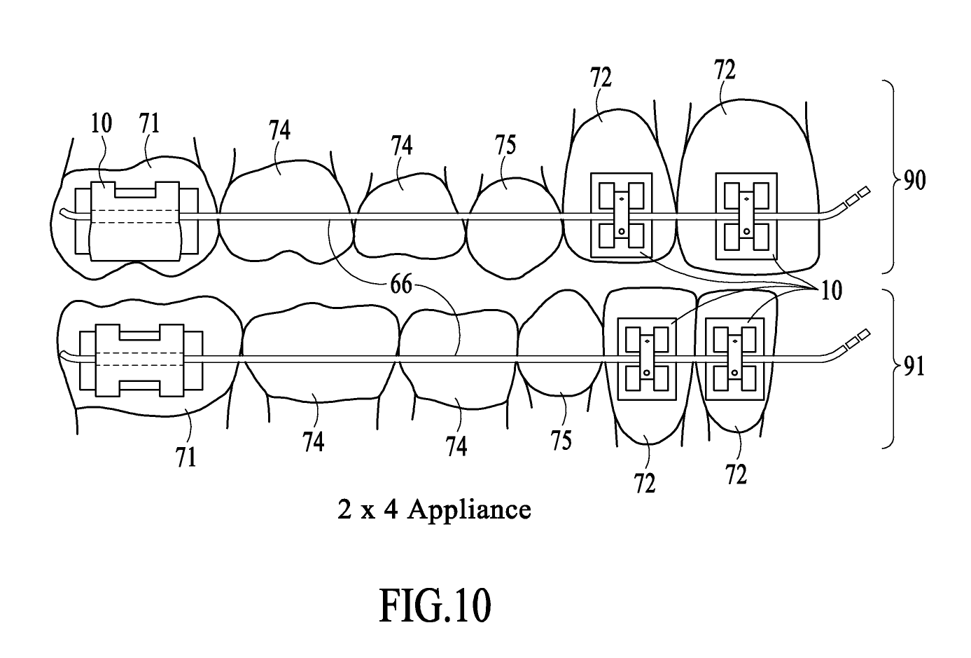

In certain circumstances orthodontic treatment is more effective when it is initiated in the mixed-dentition period. Such treatment is commonly referred to as interceptive treatment. Mixed-dentition approximates the chronological age of seven to twelve in children and is defined by the presence of combined permanent and deciduous teeth in the mouth. FIG. 10 shows an upper dental quadrant 90 and lower dental quadrant 91 exhibiting mixed dentition. During this period the permanent incisors 72 erupt in the front of the mouth replacing the anterior deciduous teeth while permanent molars 71 erupt in the back of the mouth behind the deciduous molars 74. In each side of the mouth (quadrant), one deciduous canine 75 and two deciduous molars 74 are interposed between the anteriorly positioned permanent incisors 72 and posteriorly placed permanent molar 71. In such an arrangement for correction of misaligned incisors 72, they must be anchored to the permanent molars 71 which are three teeth away in the back of the mouth, bypassing the deciduous canine 75 and deciduous molars 74.

At the present time, orthodontic treatment of any mixed-dentition case (both permanent and deciduous teeth present) involves the use of a “two-by-four” (2×4) appliance. The 2×4 designation refers to the two permanent molars 71 and four permanent incisors 72 of a mixed-dentition dental arch used for the placement of a bracket assembly 10.

A typical 2×4 appliance is shown on mixed-dentition upper and lower dental quadrants in FIG. 10. The 2×4 appliance 77 consists of bracket assemblies 10 attached to permanent molars 71, permanent incisors 72, and archwire 66 engaging bracket assemblies 10 on each quadrant. This arrangement relies on the permanent molars 71 as anchors to correct the misaligned permanent incisors 72. Unfortunately the permanent molars 71 do not provide adequate anchorage for alignment of the permanent incisors 72. Even more troubling for the patient, the 2×4 treatment may cause misalignment problems in the permanent molars 71 themselves that otherwise wouldn't have occurred. Since the archwire 66 in a 2×4 appliance system has to by-pass the three non-bracketed deciduous molars 74 and deciduous canines 75, the archwire 66 floats in a position which frequently irritates the inside of the patient's cheeks.

Inadequacy of anchorage and patient discomfort that is associated with the use of a 2×4 appliance creates reluctance for most practitioners to treat mixed-dentition cases and forces them to defer treatment to a later age when the deciduous teeth are replaced by the permanent teeth. Unfortunately, the presence of complete permanent dentition also corresponds with adolescence when most patients are not eager to wear braces, cooperate with needed auxiliary mechanics, or maintain adequate oral hygiene.

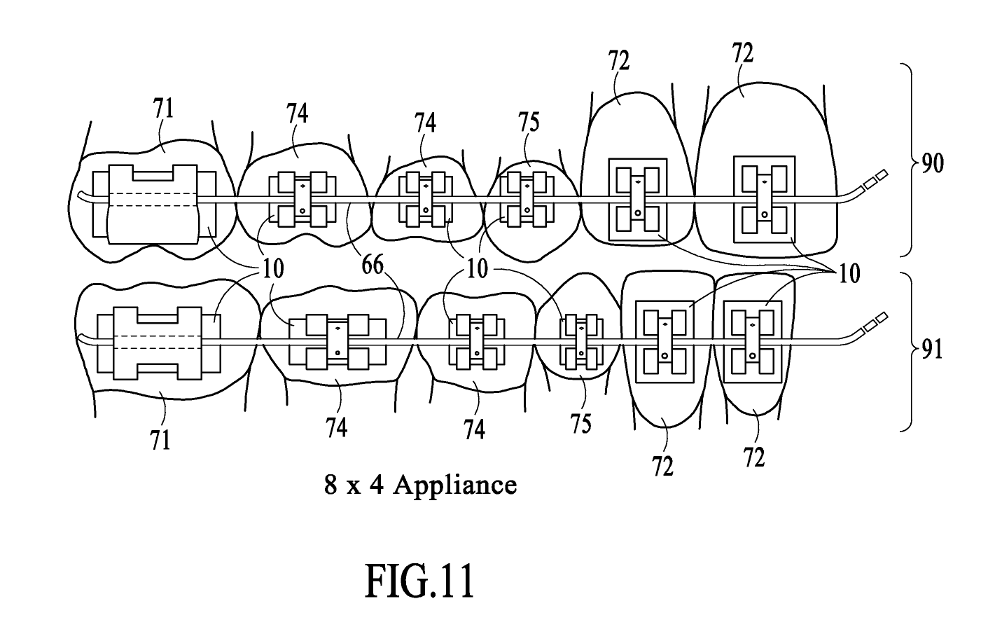

The simple design of the disclosed bracket assembly 10 allows it to be manufactured in compact dimensions, suitable for use on deciduous as well as permanent teeth. It therefore offers the possibility of more efficient mechanical systems such as an 8×4 appliance (FIG. 11) for treatment of mixed-dentition cases. In an 8×4 appliance the anchorage value of the permanent molars 71 is augmented by the use of bracket assemblies 10 on the four deciduous molars 74 and two deciduous canines 75 in the dental arch. The added anchorage helps stabilize the permanent molars 71, increases the efficiency of straightening the permanent incisors 72, and eliminates the discomfort of a wobbling unsupported span of archwire on the sides of the mouth.

Inclusion of the deciduous teeth through utilization of the disclosed self-ligating bracket assembly 10 allows for development of more effective methods for treatment of the younger patients. In addition to an 8×4 system, other design of appliances such as 4×4 or 6×4 can be utilized. The choice of appliance selection is dependent on the number of deciduous teeth that are available for inclusion as anchors.

As noted previously, this is only one possible embodiment of the claimed bracket, many alternative embodiments are possible.

I claim:

1. A self-ligating orthodontic bracket comprising:
a base for attachment to a tooth;
a body for engagement of an archwire;
mesial and distal paired tie wings;
a transverse archwire slot;
a ligating rotary plate mounted on the anterior surface of the bracket body that is movable about a pivot axis between an open position substantially in the mesio-distal plane where the archwire slot is exposed, to a closed position substantially in the occlusal-gingival plane and intermediate to mesial and distal paired tie wings, effecting ligation.

2. The orthodontic bracket of claim 1 having an extension of a lower anterior tie wing surface functioning as a rotary plate stop, preventing the rotary plate from moving substantially below the mesio-distal plane when in the open position.

3. The orthodontic bracket of claim 2 where the rotary plate is L shaped having a tab portion for manipulation of the rotary plate with the practitioner's fingers and a stem portion for retention of an archwire in the archwire slot when in the rotary plate is in closed position.

4. The orthodontic bracket of claim 3 where the rotary plate stem is pivotably secured to the bracket body by a pin.

5. The orthodontic bracket of claim 4 where the rotary plate tab secures the rotary plate in the closed position through contact with an intermediate body surface.

6. The orthodontic bracket of claim 5 where the anterior upper surface of a tie wing is contoured to facilitate movement of the rotary plate from open to closed position.

7. The orthodontic bracket of claim 1 where the rotary plate is perforated by an access slot allowing for the engagement of a tool for manipulation of the rotary plate between open and closed positions.

8. The orthodontic bracket of claim 1 using a mixture of plastic and metallic materials.

9. The orthodontic bracket of claim 1 manufactured in different colors corresponding to placement on particular teeth.
